(19) United States
(12) Patent Application Publication
(10) Pub. No.: US 2023/0283995 A1
(43) Pub. Date: Sep. 7, 2023

(54) METHOD FOR TRACKING A DEVICE, DEVICE AS WELL AS WORK SYSTEM

(71) Applicant: Workaround GmbH, München (DE)

(72) Inventors: Johannes HUTTER, München (DE); Sebastian PETRUCH, München (DE); Matthias KIRCHNER, München (DE)

(21) Appl. No.: 18/115,632

(22) Filed: Feb. 28, 2023

(30) Foreign Application Priority Data
Mar. 2, 2022 (DE) 10 2022 104 945.0

(51) Int. Cl. H04W 4/14; G06F 1/26; H04W 4/80

(52) U.S. Cl. CPC H04W 4/14; G06F 1/263; H04W 4/80

(57) ABSTRACT

A method for tracking a device of a wearable user equipment for a work system, wherein the device detects whether it is connected to a power supply, and the device transmits an identification message when it is connected to a power supply. Moreover, a device as well as a work system are shown.

### FIELD OF THE DISCLOSURE

The disclosure relates to a method for tracking a device of a user equipment of a work system, one such device as well as work system comprising one such device.

### BACKGROUND

Work systems by means of which complex processes are executed are known. Here, sub-processes or several process steps are typically executed by machines and other process steps by workers or users.

The machines may be industrial robots or wearable user devices, such as barcode readers.

The users may be instructed by wearable, personalised devices, hereinafter termed “user equipment”, in order to execute the required step correctly at that time in the complex process. For example, such user equipment includes a barcode scanner and a screen.

Examples of such work systems are assembly lines of complex products, such as cars, or large distribution warehouses.

The individual devices of the user equipment are kept as small as possible in order to not impede the worker or user during their activities. As a result, there is the risk that individual devices of the user equipment are unintentionally lost and can only be found again with difficulty.

### SUMMARY

Thus, there is provided an option by means of which a device of a wearable user equipment can be tracked easily.

For this purpose, a method for tracking a device of a wearable user equipment for a work system is provided. The method comprises the following steps:
the device detects whether it is connected to a power supply, and
the device transmits an identification message when it is connected to a power supply.

By transmitting the identification message when the device is connected to the power supply, the identification of the device is facilitated without needing comparatively complex steps for this, such as coupling the device to a connection device.

The inventors have also discovered that the transmission of identification messages is advantageous when charging although devices do not usually send information when charging as it is not necessary to track these devices.

Within the scope of this disclosure, a power supply is understood to mean the connection to a mains supply. The device includes a power storage medium, such as an accumulator.

The transmission of the identification message is understood to mean sending the identification message without any specific receiver.

The transmission of the identification message can occur at regular intervals or according to another predefined system.

Preferably, the device is wearable, in particular a secondary device to a main device or connection device and/or the device is not the connection device.

The detection and/or transmission is executed in particular by a control unit of the device.

For example, the work system has a plurality of devices.

In an embodiment, the device is a sensor and/or information device and it is attachable onto a garment of the work system, in particular a glove, thereby making the work system particularly easy to operate.

In an aspect, the identification message is transmitted using the Bluetooth protocol, in particular Bluetooth Low Energy (BLE). This reduces the power requirements.

For example, the device is a Bluetooth beacon in the period during which it transmits the identification message.

In an embodiment of the disclosure, the identification message includes an identifier of the device, information on whether the power storage medium of the device is currently being charged, the state of charge of the power storage medium, the maintenance status of the power storage medium, the elapsed charging time, the remaining charging time, the charging speed, the signal strength of received signals and/or the temperature of the power storage medium. This information impacts on the anticipated maintenance and/or service-related measures so that in this way it is possible to monitor the device simply and nearly seamlessly.

Using the signal strength of the received identification message and/or signal strength described in the identification message, the location of the device and/or the distance of the device to the base station can be inferred.

The identification is, for example, a unique identifier (universally unique identifier; UUID), the MAC address and/or the serial number of the device.

The power storage medium can be an accumulator.

For simple operation, the power supply can be a charging station, into which the device is inserted. For example, the charging station is a part of the work system.

In an embodiment, the work system comprises a base station, wherein the base station receives the identification message transmitted by the device, in particular without establishing a two-way communication link with the device, thereby enabling the use of existing infrastructure.

The base station can be a stationary device, such as an access point, or a mobile device, such as a wearable smart device, for example a smartphone, a tablet, a laptop, a smart watch or smart glasses.

The charging station is located in particular within the range of the base station. The base station can be configured to receive identification messages from several devices.

For complete documentation of the work system, the work system can comprise a process control and/or a device server in which a list of used devices is maintained, wherein the list is maintained using received identification messages that have been received by the process control and/or the device server, in particular wherein the base station transmits the received identification message to the process control and/or the device server.

To increase the reliability of the tracking, one of the devices can be flagged in the list if said one device was not in contact with the process control and/or the device server for a predetermined period of time, in particular wherein the flag is removed as soon as an identification message originating from said one device is received by the process control and/or the device server.

In an embodiment, the work system comprises a secondary device and a main device, wherein the device is the secondary device, and in particular wherein the main device is a wearable smart device, preferably a smartphone, a tablet, a laptop, a smart watch and or smart glasses. In this way, the functionality of the user equipment can be extended without increasing the dimensions of the secondary device.

To facilitate reliable interaction between the secondary device and the main device, the secondary device can be connected, in particularly connected wirelessly, to the main device for data transmission when the secondary device is disconnected from the power supply.

To reduce the power requirements, it is conceivable that the transmission of the identification message is ended when the device is disconnected from the power supply and/or that the identification message is only transmitted when the device is not connected or coupled to the process control, the device server and/or the main device.

In an embodiment, the device has a sensor, in particular an optical sensor, by means of which sensor data, in particular a representation of a barcode, is generated and/or that the device has a screen on which content is displayed. In this way, the operation of the work system is greatly simplified.

In an embodiment, the garment and/or the device comprise at least one input means, in particular a trigger, wherein at least one function of the device, in particular the sensor, is triggered by actuating the input means when the device is received by the garment, thereby enabling the device to be used particularly efficiently.

The object is also solved by a device for a work system comprising a device, in particular a sensor and/or information device, and a garment, in particular a glove, onto which the device is attachable, wherein the device is configured to execute a method described previously.

The features and advantages mentioned for the method equally apply to the device and vice versa. Here, the components of the device are configured to also execute method steps to be executed by them in the method.

Moreover, the object is solved by a work system comprising a main device, a device as previously described as a secondary device and a garment, in particular a glove, onto which the secondary device is attachable, in particular wherein the work system and/or the secondary device are configured to execute a method described previously.

The features and advantages mentioned for the method and/or the device equally apply to the work system and vice versa. Here, the components of the work system are configured to also execute method steps to be executed by them in the method.

For example, the work system comprises a charging station for the device, a process control and/or a device server.

### BRIEF DESCRIPTION OF THE DRAWINGS

Additional advantages and features of the disclosure can be found in the following description as well as in the attached drawings to which reference is made. In the drawings:

FIG. 1 shows schematically a building comprising a work system according to the disclosure,

FIG. 2 shows a user of the work system with a user equipment comprising devices of the work system according to the disclosure according to FIG. 1 as well as a charging station,

FIG. 3 shows a schematic view of a user equipment according to FIG. 2, and

FIG. 4 shows a schematic flow diagram of a method according to the disclosure.

### DETAILED DESCRIPTION

Lists having a plurality of alternatives connected by “and/or”, for example “A, B and/or C” are to be understood to disclose an arbitrary combination of the alternatives, i.e. the lists are to be read as “A and/or B and/or C” or as “at least one of A, B or C”. The same holds true for listings with more than three items.

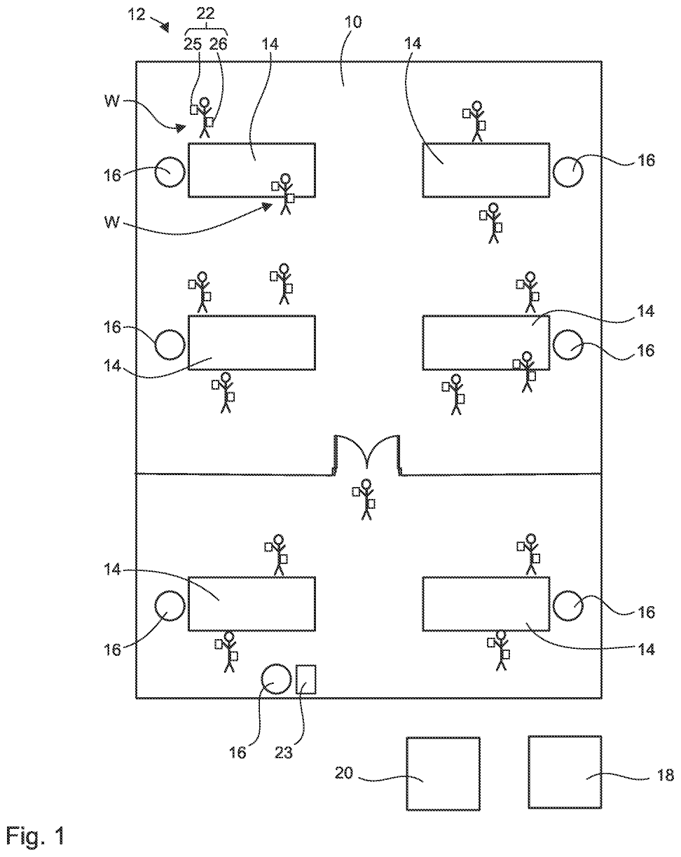

In FIG. 1, a factory building 10 as well as a work system 12 are shown extremely schematically in an aerial perspective.

The factory building 10 is a part of an operation that produces a product. For example, the product is a vehicle or parts for this.

To produce the product, a predefined process is to be executed comprising various process steps which are to be executed by users W.

Instead of the user, it is conceivable that autonomous robots or drones are used as the user W.

The entire process can be subdivided into various sub-processes to reduce the complexity of the sub-processes and increase productivity.

The entire process or also only a sub-process can be executed in the factory building 10, for example if several, spatially separated production sites are available.

The sub-process itself can be subdivided in turn into smaller sub-processes. This division can be executed multiple times, e.g. in highly complex products such as a vehicle, so that the entire process is subdivided into several hierarchical levels of sub-processes and sub-processes of the sub-processes etc. However, within the scope of this disclosure, only “sub-process” is referred to for simplification, whereby any sub-process in any hierarchical level can be meant.

Each sub-process comprises various process steps which are executed by users W at the various workstations 14.

To this end, different workstations 14 of the work system 12 are located in the factory building 10, at said workstations one or more of the process steps are executed. Thus, a specific sub-process is executed in each case at the different workstations 14.

The workstations 14 are shown in the example statically. Of course, the workstations 14 can also be sections of an assembly line productions.

In the shown embodiment, two production lines each comprising three workstations 14 are provided. The workstations 14 of a production line are adjacent each other; in FIG. 1, they are perpendicular to each other.

The production lines are thus arranged parallel to each other.

In addition, the work system 12 comprises at least one base station 16 for a wireless communication, a device server 18, a process control 20, a plurality of user equipment 22, at least one charging station 23 and several wireless connection devices 26.

The base stations 16 are arranged in such a way that their range covers at least parts of the process region (also termed shopfloor). In the example, the process region is the interior of the factory building 10 and the base stations 16 are provided in the factory building 10.

The base station 16 is a stationary device, such as an access point. It is also conceivable that the base station 16 is a mobile device, such as a wearable smart device, for example a smartphone, a tablet, a laptop, a smart watch or smart glasses.

The base stations 16 are connected to the device server 18 and the process control 20, for example via LAN or the Internet. The device server 18 and the process control 20 are thus accessible wirelessly by the user equipment 22 in the process region.

The process control 20 and/or the device server 18 are operated on one or several central computers and/or servers.

The process system 20 is, for example, an inventory management system, an enterprise resource planning system (ERP system) or suchlike and is used for monitoring, for quality management and for controlling the processes of the work system 12, e.g., the processes for producing the product.

The device server 18 is used for the administration of the user equipment 22 or the devices of the user equipment 22, in particular for the configuration, monitoring, maintenance and/or administration of the user equipment 22 or the devices of the user equipment 22.

It is also conceivable that the device server 18 is integrated into the process control 20.

Each of the user equipment 22 comprises at least one device such as a sensor device 24 and/or at least one output means 30.

The work system 12 thus includes a plurality of devices.

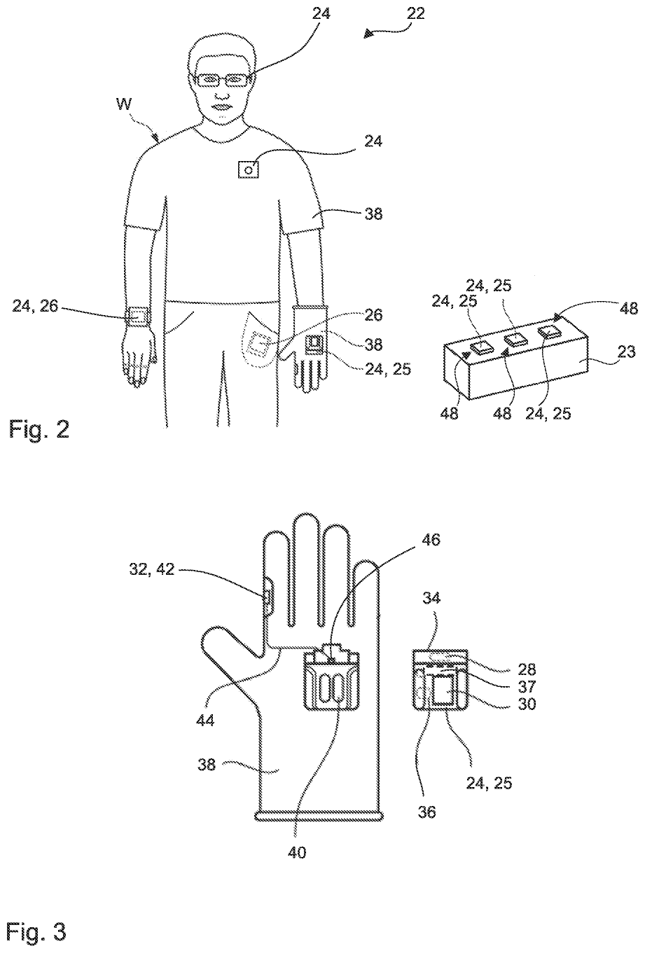

The sensor devices 24 are worn by the workers W. For example, each user W wears at least one or more sensor devices 24, as shown in FIG. 2. In addition, FIG. 2 shows an enlarged view of the charging station 23.

The sensor devices 24 comprise a sensor 28 as well as optionally an output means 30 and an actuating element 32.

The sensor devices 24 are, for example, headsets with a microphone as sensor 28 and headphones as output means 30. In addition, the headset can comprise a pushbutton as an actuating element 32.

For example, a camera, e.g., a helmet camera or a camera attached to a garment, can also be a sensor device 24 and thus a device of the user equipment 22. The camera acts as a sensor 28 and optional screens, LEDs, loud speakers or pushbuttons of the camera as output means 30 and actuating elements 32.

A barcode reading device can also be a sensor device 24 and thus a device of the user equipment 22, wherein the barcode reader of the barcode reading device is the sensor 28 and optional screens, LEDs, loudspeakers or pushbuttons of the camera act as output means 30 or actuating elements 32.

Within the scope of this disclosure, a barcode is understood to mean any code, such as barcodes, matrix codes, QR codes and suchlike.

Sensor devices 24 and thus devices of the user equipment 22 can also be wearable sensor and/or information devices 25, as are known as the secondary device from DE 10 2019 118 969 A1 or DE 10 2020 106 369 A1.

The sensor and/or information device 25 has the sensor 28, an optional screen as output means 30, a control unit 34 comprising a communication module 36 and a power storage medium 37, such as an accumulator.

In addition, the sensor and/or information device 25 has the actuating element 32, for example in the form of a pushbutton or owing to the fact that the screen is configured to be touch sensitive.

The sensor and/or information device 25 is in particular a device whose function is limited to specialized applications. To this end, it can be an embedded system and/or have a compact form.

For example, the sensor and/or information device 25 is not a multi-functional device, therefore not a smart device, such as a smartphone, a tablet, a smart watch or smart glasses.

However, it should be noted that this embodiment is purely exemplary for illustration purposes. Alternatively, the sensor and/or information device 25 can be designed without a screen or without a sensor 28. In these cases, the sensor and/or information device 25 is merely a sensor device or an information device.

It is also conceivable that the sensor device 24 and thus the device of the user equipment 22 is a smart device, such as a smartphone, a tablet, a smart watch or smart glasses. The sensor 28 is, for example, an optical sensor, such as a barcode reader or a camera. It is also conceivable that the sensor and/or information device 25 as the sensor 28 comprises other sensors, such as an RFID reader, touch sensors or acceleration sensors, in addition to or instead of the optical sensor.

What all these embodiments of the device of the user equipment 22 have in common is that they are wearable, i.e., comprise an accumulator and must not be permanently connected to the mains supply for operation.

As can be seen in FIG. 3, the user equipment 22 and thus the work system 12 comprises in addition a garment 38, in particular a glove, by means of which the sensor and/or information device 25 can be fastened to the body of the user W. The sensor and/or information device 25 or the user equipment 22 is thus what is termed a “wearable”.

To this end, the garment 38 has a holder 40, into which the sensor and/or information device 25 can be fastened and removed without tools in a repeatable manner.

The garment 38 can also have an input means 42, for example a trigger for the sensor and/or information device 25. The trigger or the input means 42 can be provided on a finger of the glove. It is also conceivable that said at least one input means 42 or one or several additional input means 42 are provided on the holder 40.

By means of at least one cable 44 and at least one contact 46 in the holder 40, the input means 42 is connected to the sensor and/or information device 25 as soon as the sensor and/or information device 25 is inserted into the holder 40.

The input means 42 on the garment 38 can thus also be regarded as an actuating element 32 of the sensor and/or information device 25.

The charging station 23 is connected to the mains supply and is used for charging the power storage medium 37 of the devices of the user equipment 22, in particular the secondary devices.

The charging station 23 is provided, for example, for the sensor devices 24 and/or the sensor and/or information devices 25.

The charging station 23 comprises several charging docks 48 (FIG. 2) into which in each case a device can be inserted and thus can be connected to the mains supply.

The charging station 23 is located within the range of one of the base stations 16.

In particular, one of the base stations 16, which is in the range of the charging station 23, is configured as a dedicated monitoring station. As such, the monitoring station does not couple itself to the devices of the user equipment 22, nor to the connection devices 26, but rather only receives signals that are transmitted by the devices in the charging station 23.

The connection devices 26 are devices that typically have larger computing power as the sensor devices 24, in particular the sensor and/or information devices 25. For example, the connection devices 26 are designed as smart devices, such as a smartphone, a tablet, a smart watch or smart glasses, or a wristband equipped with corresponding processors and communication modules.

In this case, the connection devices 26 are also mobile and are worn by the user W. They are then part of the user equipment 22.

The combination of the sensor and/or information device 25 and connection device 26 corresponds, for example, to the sensor and information system comprising the secondary device (sensor and/or information device 25) and main device (connection device 26) of DE 10 2019 118 969 A1 or DE 10 2020 106 369 A1.

It is however conceivable that the connection device 26 is integrated into the sensor device 24 or the sensor and/or information device 25.

On the one hand, the connection devices 26 maintain a communication link to the process control 20 and, on the other hand, a communication link to the sensor devices 24 or the sensor and/or information devices 25 assigned to them.

The communication link between the connection device 26 and the process control 20 occurs in each case via one of the base stations 16 and is thus wireless from the connection device 26.

The communication link between the connection device 26 and the sensor devices 24 or the sensor and/or information devices 25 assigned to them also occurs wirelessly, for example using another protocol. A wired communication link is however also conceivable here.

To produce the product, the users W work at the various workstations 14 with the help of the user equipment 22 that has been assigned to them and that they wear on their bodies.

While the user W at one of the workstations 14 executes the process steps belonging to the sub-process of this workstation 14, the user W uses the sensors 28 of the sensor devices 24 or the sensors 28 are activated automatically.

For example, before installing a component on the product, the worker W must capture a barcode of the product by means of the sensor 28 of the sensor and/or information device 25. To read the barcode, the worker W triggers, for example, the sensor 28 by actuating the input means 42 on the garment 38.

As a result, sensor data is generated, in the described example the value of the barcode, an image of the barcode or the entire image recorded by the barcode reader.

Further examples for sensor data are accelerations, specific acceleration patterns, for example, steps, movement sequences, such as turning movements of the hand for tightening bolts, or gestures, scanned RFID tags and/or temperature measurements.

The sensor data generated by the sensor device 24 is then transmitted to the connection device 26. The connection device 26 transmits the sensor data then on to the process control 20. This can take place by means of device-internal transmissions provided that parts of the process control 20 are configured on the connection device 26.

The process control 20 can then instruct or control the sensor device 24 or the sensor and/or information device 25 to execute at least in part a sub-process or process steps, in particular, this is the sub-process or are the process steps that were assigned to the corresponding workstation 14 or even the exact sensor device 24 or the sensor and/or information device 25. To this end, the sub-processes or process steps assigned to the different sensor devices 24 of a user W may differ.

For example, the process control 20 now checks the obtained sensor data, thus in this case the barcode, with the intended process steps that are executed in the factory building 10 or at the special workstation 14.

In the process control 20, the sub-processes and process steps are stored so that the process control 20 already expects certain sensor data from the sensor device 24 or the sensor and/or information device 25. The process control 20 can now compare the obtained sensor data with the expected sensor data and as a result of the comparison provide feedback to the user W.

Moreover, the process control 20 transmits a control instruction to the same or another sensor device 24 or the same or another sensor and/or information device 25 in order to instruct the user W.

For example, the user W can be informed about whether the user W wants to mount the correct component or has read the correct barcode. The user W can also be transmitted further information by means of the output means 30. To this end, the control instruction comprises, for example, information, in particular text, which is to be shown on the screen of the sensor and/or information device 25.

The control instruction is transmitted by the process control 20 to the corresponding sensor device 24 or the corresponding sensor and/or information device 25 by means of the connection device 26.

The corresponding sensor device 24 or the corresponding sensor and/or information device 25 receives the control instruction and executes the instructions received in the control instruction.

The user W can then proceed to the next process step or, if other instructions are communicated, execute these.

To this end, the connection device 26 can assume all or parts of these activities of the process control 20 for the purpose of informing and guiding the user. For example, this is disclosed in DE 10 2019 118 969 A1 or DE 10 2020 106 369 A1, in which the monitoring of the correct execution of action sequences—termed sub-processes here—is described in detail. This monitoring can also be executed by the process control 20.

The individual sub-processes are stored in the process control 20 and/or on the device server 18.

The described example of a factory building for producing products is to be understood as merely exemplary. Applications of the method according to the disclosure are also conceivable in other processes. Further examples are warehousing and logistics processes, in which sub-processes are executed such as unpacking goods, filling the warehouse, the targeted procurement of goods from the warehouse (what is termed “picking”) and/or the packaging of these goods for dispatch. Even in these sub-processes, the users W can use their own user equipment 22 that needs to be configured for the respective sub-process. In this case, the workstations 14 are, for example, goods shelves or packing stations.

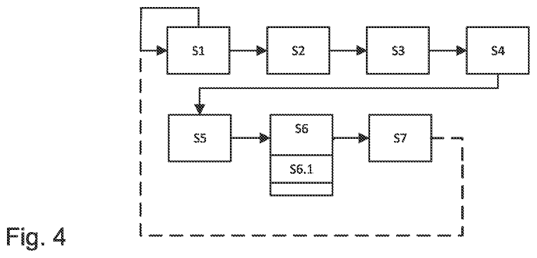

The method according to the disclosure shown in FIG. 4 as a flow diagram is applied for monitoring and tracking the devices of the user equipment 22.

Without limiting generality, a sensor device 24 or a sensor and/or information device 25 is assumed to be hereinafter the device of the user equipment 22 that is to be tracked.

In particular, the connection device 26 is not the device that is tracked.

The device checks whether it is connected to a power supply according to a predetermined schedule, for example at regular intervals.

A power supply is thus understood to be mean the device being connected directly to the mains supply. Within the scope of this disclosure, the power storage medium 37 does not therefore constitute a power supply.

Transferred to the example, it is thus checked whether the device is inserted into one of the charging docks 48 of the charging station 23. This check can be carried out for example by the control unit 34.

The check can also occur when the device is connected to a connection device 26 or a base station 16, i.e., while the device is being used by a user W.

It is also possible that the recognition as to whether the device is connected to the power supply, is not executed by the user W during use. Using the existing communication link to the connection device 26 or a base station 16, it is possible to detect through the control unit 34 whether the device is in use.

After the user W has finished the activities with the device, the user W inserts the device into one of the charging docks 48 of the charging station 23 and thus connects it to the power supply.

It is also conceivable that a previously lost device is found again after a while by someone, for example another user W, and subsequently inserted into one of the charging docks 48 of the charging station 23.

As soon as the device is inserted into the charging station 23, it detects that it is connected to the power supply (step S2).

As soon as the device determines that it is connected to a power supply, the device transmits an identification message.

For example, the control unit 34 can detect the connection to the power supply and then generates an identification message that is then transmitted in step S3 by means of the communication module 36.

Within the scope of this disclosure, transmission is understood to mean that the identification message is transmitted by means of the communication module 36 without being addressed to a specific receiver. Contrary to the sending of messages, this applies in particular while the device is coupled to another device
such as a connection device 26—as in this case the messages are addressed to the coupled device and were intended for this.

The Bluetooth protocol can be used, in particular the Bluetooth Low Energy protocol, for transmitting the identification message. In doing so, so-called “Bluetooth beaconing” functions are used so that the device constitutes a Bluetooth beacon during the period during which it transmits the identification message.

In the next step S4, that base station 16 which is located in the range of the charging station 23 receives the transmitted identification message. In particular, the base station 16 does not produce a two-way connection to the device, i.e., the base station 16 and the device are not coupled to each other, but rather the base station 16 only receives the identification message without any feedback.

The base station 16 also receives the transmitted identification message of other devices of the work system 12 that are located in the charging station 23.

In step S5, the base station 16 transmits the identification message to the device server 18 and/or the process control 20, which then tracks the device in step S6 using the identification message and/or monitors the operating parameters of the device.

For example, the identification message contains an identifier of the device, such as a unique identifier (universally unique identifier; UUID), the MAC address and/or the serial number of the device.

The identification messages can also contain technical information about the device, for example, whether the power storage medium 37 of the device is currently being charged, the state of charge of the power storage medium 37, the maintenance status of the power storage medium 37 (also called “battery health”), the elapsed charging time, the remaining charging time to a full charge, the charging speed and/or the temperature of the power storage medium 37.

This data can be determined by the control unit 34 that generates the identification message using this data.

To track and monitoring the devices, the process control 20 and/or the device server 18 maintains a list with the devices that are available and used in the work system 12.

In this list, information can be collated on individual devices, such as the last known location, the last and currently executed sub-process and/or technical information, such as the maintenance status of the power storage medium 37,

The process control 20 and/or the device server 18 can determine further technical information, such as the need for replacing or servicing the device, using further information that is contained in the identification message.

One of the devices can be flagged in the list for tracking, for example when this device has not been active for a predetermined period of time, i.e., a communication link has not been established to a connection device 26 or one of the base stations 16 and was therefore not in contact with the device server 18 and/or the process control 20. The flag is then used, for example, to highlight lost devices.

As soon as the process control 20 or the device server 18 then receives an identification message on a device that has been flagged in the list (identified by the identifier of the device in the identification message), the process control or the device server 18 regards this device as being found and removes the flag from the list (step S6.1).

In this case, it must be taken into account that a device is thus recognised as found or rather no longer lost without needing the device to establish a communication link to a communication device 26 or a base station 16. This system also prevents devices being flagged that have been left unused in the charging station 23 for a long time, even though they were not active beyond the predetermined period of time.

If a device is removed again from the charging station 23 (step S7), for example at the start of a new shift, it is disconnected from the power supply.

The control unit 34 detects the disconnection from the power supply and ends the transmission of the identification message.

To reduce the amount of transmitted identification messages, it is conceivable that identification messages are only transmitted if the device is not coupled to the process control 20, the device server 18, a base station 16 and/or a connection device 26.

In this way, it is possible to track and monitor the devices of the work system 12 particularly simply and yet promptly.

1. A method for tracking a device of a wearable user equipment for a work system, wherein the method comprises the following steps:
the device detects whether it is connected to a power supply, and
the device transmits an identification message when it is connected to the power supply.

2. The method according to claim 1, wherein the device is at least one of a sensor or information device and is attachable onto a garment of the work system.

3. The method according to claim 1, wherein the identification message is transmitted using Bluetooth protocol.

4. The method according to claim 1, wherein the identification message includes at least one of an identifier of the device, information on whether a power storage medium of the device is currently being charged, a state of charge of the power storage medium, a maintenance status of the power storage medium, an elapsed charging time, a remaining charging time, a charging speed, a signal strength of received signals, or a temperature of the power storage medium.

5. The method according to claim 1, wherein the power supply is a charging station, into which the device is inserted.

6. The method according to claim 1, wherein the work system comprises a base station, wherein the base station receives the identification message transmitted by the device.

7. The method according to claim 6, wherein the base station receives the identification message transmitted by the device without establishing a two-way communication link with the device.

8. The method according to claim 1, wherein the work system comprises at least one of a process control or a device server in which a list of used devices is maintained, wherein the list is maintained using received identification messages that have been received by at least one of the process control or the device server.

9. The method according to claim 8, wherein one of the devices is flagged in the list if said one device did not make contact with at least one of the process control or the device server for a predetermined period of time,

10. The method according to claim 9, wherein the flag is removed as soon as an identification message originating from said one device is received by at least one of the process control or the device server.

11. The method according to claim 1, wherein the work system comprises a secondary device and a main device, wherein the device is the secondary device.

12. The method according to claim 1, wherein a transmission of the identification message is ended when the device is disconnected from the power supply.

13. The method according to claim 1, wherein the identification message is only transmitted when the device is not connected or coupled to at least one of a process control, a device server, or a main device.

14. The method according to claim 1, wherein the device has at least one of a sensor by means of which sensor data is generated or a screen on which content is displayed.

15. The method according to claim 1, wherein at least one of a garment or the device comprise at least one input means, wherein at least one function of the device, is triggered by actuating the input means when the device is received in the garment.

16. The method according to claim 15, wherein the at least one input means is a trigger.

17. A device for a work system comprising the device and a garment onto which the device is attachable, wherein the device is configured to execute a method for tracking the device of a wearable user equipment for the work system, wherein the method comprises the following steps:
the device detects whether it is connected to a power supply, and
the device transmits an identification message when it is connected to the power supply.

18. A work system comprising a main device, a secondary device and a garment onto which the secondary device is attachable, wherein at least one of the work system or the secondary device are configured to execute a method for tracking the secondary device, wherein the method comprises the following steps:
the secondary device detects whether it is connected to a power supply, and
the secondary device transmits an identification message when it is connected to the power supply.

19. The work system according to claim 18, wherein the garment is a glove.

20. The work system according to claim 18, wherein the work system comprises at least one of a charging station for the device, a process control, or a device server.
